(19) United States
(12) Patent Application Publication
(10) Pub. No.: US 2012/0133243 A1
(43) Pub. Date: May 31, 2012

(54) ACTUATOR AND ACTUATOR MANUFACTURING METHOD

(75) Inventors: Hidenori Okuzaki, Kofu-Shi (JP); Hu Yan, Kofu-Shi (JP)

(73) Assignees: UNIVERSITY OF YAMANASHI, Kofu-Shi, Yamanashi (JP); TOKYO ELECTRON LIMITED, Tokyo (JP)

(21) Appl. No.: 13/387,167

(22) PCT Filed: Jul. 23, 2010
(86) PCT No.: PCT/JP2010/062458

§ 371 Date: Jan. 26, 2012

(30) Foreign Application Priority Data
Jul. 28, 2009 (JP) 2009-175333
Aug. 28, 2009 (JP) PCT/JP2009/065051

(51) Int. Cl. H02N 11/00; B29C 39/42; B82Y 15/00

(52) U.S. Cl. 310/300; 264/571; 977/742; 977/932

(57) ABSTRACT

There is provided an actuator including a displacement unit made of a mixture of a silicone-containing elastomer and an ionic liquid; and multiple electrodes provided to apply an electric field to a part or whole of the displacement unit. Here, the displacement unit is deformed by applying a voltage between the multiple electrodes.

### TECHNICAL FIELD

The present disclosure relates to an actuator and an actuator manufacturing method.

### BACKGROUND ART

In medical technology or micromachining technology, a small and lightweight actuator has been highly demanded.

If the actuator is miniaturized, a frictional force or a viscous force rather than an inertial force becomes dominant. Therefore, it has been regarded that it is difficult to miniaturize the actuator capable of converting energy into motion by the inertial force, like a motor or an engine. As miniature actuators developed so far, an electrostatic attractive force-type actuator, a piezoelectric actuator, an ultrasonic actuator, and a shape-memory alloy-type actuator have been known.

However, since these actuators are made of inorganic materials such as metal or ceramic, the actuators have limitations in flexibility and weight lightening. Further, these actuators are not suitable for miniaturization due to their complex structure.

In order to solve these problems, various actuators made of organic materials have been developed.
Patent Document 1: Japanese Patent Laid-open Publication No. 2008-228542
Patent Document 2: Japanese Patent Laid-open Publication No. 2008-252958
Patent Document 3: Japanese Patent Laid-open Publication No. 2009-033944

### DISCLOSURE OF THE INVENTION

### Problems to be Solved by the Invention

Among actuators made of organic materials, very few actuators can be stably operated in the air with a low voltage.

The present disclosure provides an actuator made of organic materials, and an actuator manufacturing method. The actuator can be operated stably in the air with a low voltage and has a large displacement amount.

### Means for Solving the Problems

In accordance with one aspect of the present disclosure, there is provided an actuator including a displacement unit made of a mixture of a silicone-containing elastomer and an ionic liquid; and multiple electrodes provided to apply an electric field to a part or whole of the displacement unit. Here, the displacement unit may be deformed by applying a voltage between the multiple electrodes.

The displacement unit may have a flat plate shape, and the multiple electrodes may be provided on both surfaces of the displacement unit.

Further, the ionic liquid may be one selected from 1-ethyl-3-methylimidazolium tetrafluoroborate, 1-butyl-3-methylimidazolium tetrafluoroborate, 1-hexyl-3-methylimidazolium tetrafluoroborate, 1-ethyl-3-methylimidazolium2-(2-methoxyethoxy)ethyl sulfate, 1-ethyl-3-methylimidazolium bis(trifluoromethanesulfonyl)imide, and 1-butyl-1-methylpyrrolidinium bis(trifluoromethanesulfonyl) imide.

Furthermore, the ionic liquid contained in the mixture may be about 40 wt % or less.

Moreover, the multiple electrodes may be made of one selected from gold, a carbon nanotube, a conductive polymer, and silver grease.

Further, the displacement unit may be deformed by being curved.

Furthermore, the displacement unit may be deformed in a thickness direction thereof.

In accordance with another aspect of the present disclosure, there is provided an actuator manufacturing method that includes producing a mixed solution by mixing a silicone-containing elastomer and an ionic liquid; supplying the mixed solution into a mold; after supplying the mixed solution into a mold, removing air contained in the mixed solution; after removing air contained in the mixed solution, performing a heat treatment on the mixed solution; and after performing a heat treatment, taking a solid mixture solidified from the mixed solution out of the mold and providing multiple electrodes on the solid mixture.

### EFFECT OF THE INVENTION

In accordance with the present disclosure, it may be possible to provide an actuator made of organic materials and an actuator manufacturing method. The actuator can be operated stably in the air with a low voltage and has a large displacement amount.

### BRIEF DESCRIPTION OF THE DRAWINGS

FIG. 1 is a configuration view of an actuator in accordance with a first embodiment.

FIG. 2 is a flowchart of an actuator manufacturing method in accordance with the first embodiment.

FIG. 3A is a picture (1) showing an operation state of the actuator in accordance with the first embodiment.

FIG. 3B is a picture (2) showing an operation state of the actuator in accordance with the first embodiment.

FIG. 4A is an explanatory diagram (1) showing an operation state of the actuator in accordance with the first embodiment.

FIG. 4B is an explanatory diagram (2) showing an operation state of the actuator in accordance with the first embodiment.

FIG. 5A shows a relationship (1) between a compression pressure and a displacement amount in a sample made of a mixture of an ionic liquid and an elastomer.

FIG. 5B shows a relationship (2) between a compression pressure and a displacement amount in a sample made of a mixture of an ionic liquid and an elastomer.

FIG. 5C shows a relationship (3) between a compression pressure and a displacement amount in a sample made of a mixture of an ionic liquid and an elastomer.

FIG. 5D shows a relationship (4) between a compression pressure and a displacement amount in a sample made of a mixture of an ionic liquid and an elastomer.

FIG. 5E shows a relationship (5) between a compression pressure and a displacement amount in a sample made of a mixture of an ionic liquid and an elastomer.

FIG. 6 shows a relationship between composition of an ionic liquid and a compression elastic modulus in a sample made of a mixture of an ionic liquid and an elastomer.

FIG. 7 shows a relationship between a frequency of an applied AC voltage and capacitance in a sample made of a mixture of an ionic liquid and an elastomer.

FIG. 8 is a waveform view of a voltage applied to an actuator in accordance with an experimental example 1.

FIG. 9 shows a displacement amount of the actuator of the experimental example 1 when the voltage shown in FIG. 8 is applied.

FIG. 10 shows a current flowing when the voltage shown in FIG. 8 is applied.

FIG. 11 is a waveform view of a voltage applied to an actuator in accordance with a comparative example 1.

FIG. 12 shows a displacement amount of the actuator of the comparative example 1 when the voltage shown in FIG. 11 is applied.

FIG. 13 shows a current flowing when the voltage shown in FIG. 11 is applied.

FIG. 14 is a waveform view of voltages applied to an actuator in accordance with an experimental example 2.

FIG. 15 shows a displacement amount of the actuator of the experimental example 2 when the voltages shown in FIG. 14 are applied.

FIG. 16 shows a relationship between the voltages applied to the actuator and the maximum displacement amount in accordance with the experimental example 2.

FIG. 17 is a configuration view of an actuator in accordance with a second embodiment.

FIG. 18A is an explanatory view (the first half) showing stress characteristics of a silicone-containing elastomer.

FIG. 18B is an explanatory view (the first half) showing a current flowing through the silicone-containing elastomer.

FIG. 18C is an explanatory view (the first half) showing a voltage applied to the silicone-containing elastomer.

FIG. 19A is an explanatory view (the latter half) showing stress characteristics of the silicone-containing elastomer.

FIG. 19B is an explanatory view (the latter half) showing a current flowing through the silicone-containing elastomer.

FIG. 19C is an explanatory view (the latter half) showing a voltage applied to the silicone-containing elastomer.

FIG. 20A is an explanatory view showing stress characteristics of the mixture of the silicone-containing elastomer and the ionic liquid.

FIG. 20B is an explanatory view showing a current flowing through the mixture of the silicone-containing elastomer and the ionic liquid.

FIG. 20C is an explanatory view showing a voltage applied to the mixture of the silicone-containing elastomer and the ionic liquid.

FIG. 21 is a correlation view between a voltage applied and stress of two kinds of elastomer.

FIG. 22 is a stress strain characteristic view of the mixture of the silicone-containing elastomer and the ionic liquid.

FIG. 23 is a thermal stress strain characteristic view of the mixture of the silicone-containing elastomer the ionic liquid.

### BEST MODE FOR CARRYING OUT THE INVENTION

Hereinafter, embodiments of the present disclosure will be described.

### First Embodiment

### Actuator

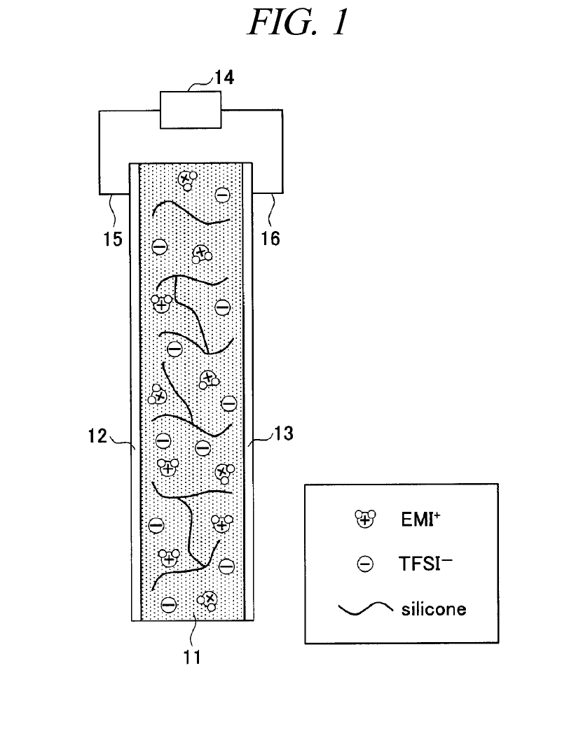

An actuator in accordance with a first embodiment will be explained with reference to FIG. 1. An actuator in accordance with the present embodiment includes a flat plate-shaped displacement unit 11 made of a mixture of an ionic liquid and a silicone-containing elastomer; and electrodes 12 and 13 provided on both surfaces of the flat plate-shaped displacement unit 11. The electrodes 12 and 13 are respectively connected to a power supply 14 via electric wires 15 and 16, so that a voltage can be applied from the power supply 14 to the electrodes 12 and 13.

As the silicone-containing elastomer for the displacement unit 11, polydimethylsiloxane expressed by a chemical formula 3 may be used. The polydimethylsiloxane is produced by a cross-linking reaction between DV-PDMS (α, ω-divinyl-polydimethylsiloxane) expressed by a chemical formula 1 and PMHS (polymethyl hydrogen siloxane) expressed by a chemical formula 2.

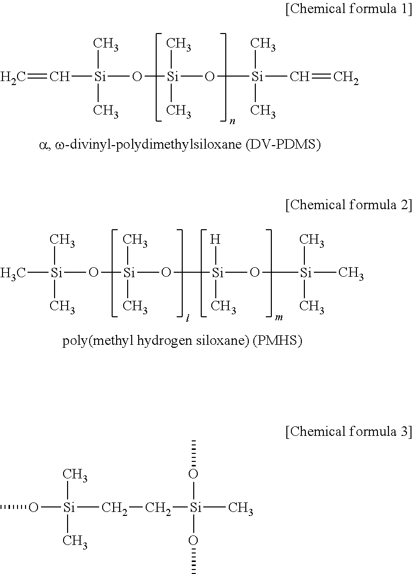

As described above, the displacement unit 11 of the present embodiment is made of the mixture of the silicone-containing elastomer and the ionic liquid. However, not all of a mixture of a silicone-containing liquid phase elastomer source material and an ionic liquid is solidified (elastomeric). That is, generally, a material included in the silicone-containing liquid phase elastomer source material is a non-polar solution. The non-polar solution is easily soluble in a non-polar solvent such as benzene or toluene but insoluble in a polar solvent such as water or alcohol. For this reason, typically, it has been regarded that the silicone-containing liquid phase elastomer source material cannot be mixed with the polar solvent such as the ionic liquid.

Under the circumstances, it has been found that there exist ionic liquids which can be easily mixed with the silicone-containing liquid phase elastomer source material and can be hardened to be solidified in the mixture thereof. The present disclosure is derived based on this finding.

As the ionic liquid, an imidazolium salt, a piperidinium salt, a pyridinium compound, or a pyrrolidinium salt may be used. The ionic liquid to be solidified in the mixture with the silicone-containing liquid phase elastomer source material may include 1-ethyl-3-methylimidazolium tetrafluoroborate ([EMI][BF₄]) expressed by a chemical formula 4,

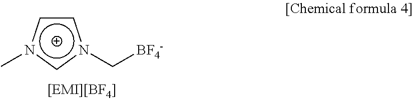

1-butyl-3-methylimidazolium tetrafluoroborate ([BMI][BF₄]) expressed by a chemical formula 5,

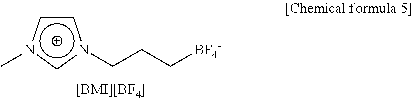

1-hexyl-3-methylimidazolium tetrafluoroborate ([HMI][BF₄]) expressed by a chemical formula 6,

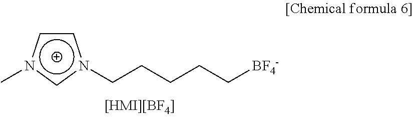

1-ethyl-3-methylimidazolium2-(2-methoxyethoxy)ethyl sulfate ([EMI][MEES]) expressed by a chemical formula 7,

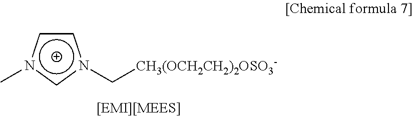

1-ethyl-3-methylimidazolium bis(trifluoromethanesulfonyl)imide ([EMI][TFSI]) expressed by a chemical formula 8, or

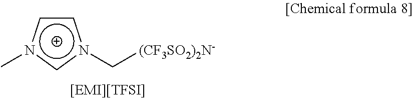

1-butyl-1-methylpyrrolidinium bis(trifluoromethanesulfonyl)imide ([BMP][TFSI]) expressed by a chemical formula 9.

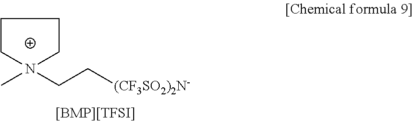

The above-described six liquids have been verified as the ionic liquid to be solidified in the mixture with the silicone-containing liquid phase elastomer source material.

Meanwhile, there exist ionic liquids not to be solidified in the mixture with the silicone-containing liquid phase elastomer source material. Such ionic liquids may include 1,3-dimethylimidazolium dimethylphosphate ([DMI][DP]) expressed by a chemical formula 10,

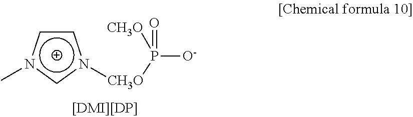

1-ethyl-3-methylimidazolium methanesulfonate ([EMI][MS]) expressed by a chemical formula 11, or

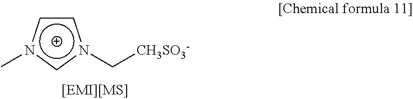

1-ethyl-3-methylimidazolium dicyanamide ([EMI][DC]) expressed by a chemical formula 12.

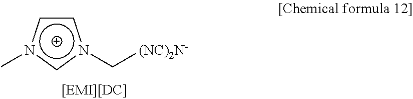

That is, a mixture of the silicone-containing liquid phase elastomer source material and any one of the ionic liquids expressed by the chemical formulas 10 to 12 remains in a liquid phase without being solidified. Thus, the mixture cannot be kept in a stable shape. However, a mixture of the present embodiment, i.e. a mixture of the silicone-containing liquid phase elastomer source material and any one of the six ionic liquids expressed by the chemical formulas 4 to 9 can be solidified, so that it can be kept in a certain shape. Therefore, the mixture can be used as a material of an actuator.

In addition to the above-described ionic liquids, there may be ionic liquids, which can be solidified in a mixture with the silicone-containing liquid phase elastomer source material, such as cyclohexyltrimethylammonium bis(trifluoromethanesulfonyl)imide, methyltri-n-octylammonium bis(trifluoromethanesulfonyl)imide, tetrabutylammonium bromide, tetrabutylammonium chloride, tetrabutylphosphonium bromide, tributyl(2-methoxyethyl)phosphonium bis(trifluoromethanesulfonyl)imide, triethylsulfonium bis(trifluoromethanesulfonyl)imide, 1,3-dimethylimidazolium chloride, 1-butyl-2,3-dimethylimidazolium bis(trifluoromethanesulfonyl)imide, 1-butyl-2,3-dimethylimidazolium chloride, 1-butyl-2,3-dimethylimidazolium hexafluorophosphate, 1-butyl-2,3-dimethylimidazolium polyethylene glycol hexadecyl ether sulfate coated lipase, 1-butyl-2,3-dimethylimidazolium tetrafluoroborate, 1-butyl-3-methylimidazolium bis(trifluoromethanesulfonyl)imide, 1-butyl-3-methylimidazolium bromide, 1-butyl-3-methylimidazolium chloride, 1-butyl-3-methylimidazolium hexafluorophosphate, 1-butyl-3-methylimidazolium iodide, 1-butyl-3-methylimidazolium tetrachloroferrate, 1-butyl-3-methylimidazolium trifluoromethanesulfonate, 1-ethyl-2,3-dimethylimidazolium bis(trifluoromethanesulfonyl)imide, 1-ethyl-3-methylimidazolium bromide, 1-ethyl-3-methylimidazolium chloride, 1-ethyl-3-methylimidazolium ethyl sulfate, 1-ethyl-3-methylimidazolium hexafluorophosphate, 1-ethyl-3-methylimidazolium hydrogen sulfate, 1-ethyl-3-methylimidazolium iodide, 1-ethyl-3-methylimidazolium tetrachloroferrate, 1-ethyl-3-methylimidazolium trifluoromethanesulfonate, 1-hexyl-3-methylimidazolium bromide, 1-hexyl-3-methylimidazolium chloride, 1-hexyl-3-methylimidazolium hexafluorophosphate, 1-methyl-3-n-octylimidazolium bromide, 1-methyl-3-n-octylimidazolium chloride, 1-methyl-3-n-octylimidazolium hexafluorophosphate, 1-methyl-3-propylimidazolium iodide, 1-butyl-1-methylpiperidinium bromide, 1-butyl-3-methylpyridinium bromide, 1-butyl-4-methylpyridinium bromide, 1-butyl-4-methylpyridinium chloride, 1-butyl-4-methylpyridinium hexafluorophosphate, 1-butylpyridinium bromide, 1-butylpyridinium chloride, 1-butylpyridinium hexafluorophosphate, 1-ethyl-3-(hydroxymethyl)pyridinium ethyl sulfate, 1-ethyl-3-methylpyridinium ethyl sulfate, 1-ethylpyridinium bromide, 1-ethylpyridinium chloride, 1-butyl-1-methylpyrrolidinium bromide, and 1-butyl-1-methylpyrrolidinium chloride.

(Actuator Manufacturing Method)

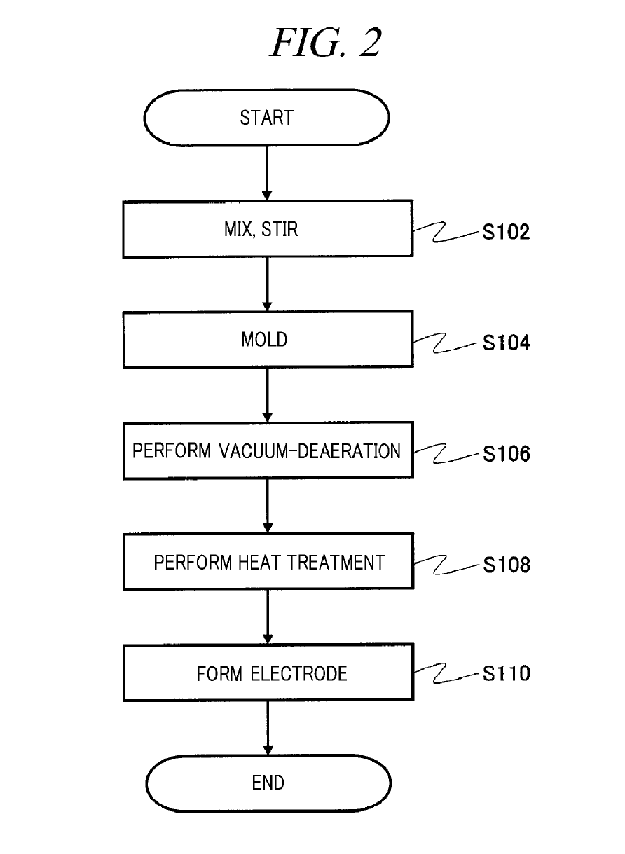

Hereinafter, an actuator manufacturing method in accordance with the present embodiment will be explained with reference to FIG. 2.

As shown in process 102 (S102), a mixed solution is produced by mixing a silicone-containing liquid phase elastomer source material with an ionic liquid. To be specific, as described above, a liquid phase elastomer source material is produced by mixing the DV-PDMS expressed by the chemical formula 1 with the PMHS expressed by the chemical formula 2, and the liquid phase elastomer source material is mixed with the ionic liquid. Then, the mixture of the liquid phase elastomer source material and the ionic liquid is heated, and the polydimethylsiloxane expressed by the chemical formula 3 is produced by the cross-linking reaction. The polydimethylsiloxane is used as the silicone-containing elastomer. Further, the above-described ionic liquids may be used. In the present embodiment, the [EMI][TFSI] expressed by the chemical formula 8 is used as the ionic liquid, and the mixed solution is produced by mixing the [EMI][TFSI] with the polydimethylsiloxane. Here, a mixed amount of the [EMI][TFSI] as the ionic liquid may be about 40 wt %.

Subsequently, as shown in process 104 (S104), the mixed solution produced in process S102 is supplied into a mold for forming the solution in a desired shape of the displacement unit.

Thereafter, as shown in process 106 (S106), vacuum deaeration is performed. To be specific, after the mixed solution is supplied into the mold, the mold is placed within a vacuum oven, and an inside of the oven is exhausted. In this way, the vacuum deaeration is performed. Thus, air contained in the mixed solution within the mold can be removed.

Then, as shown in process 108 (S108), a heat treatment is performed. To be specific, the heat treatment is performed at about 150° C. for about 30 minutes. Thereafter, by removing the mold, the displacement unit of the actuator, made of the mixture of the silicone-containing elastomer and the ionic liquid, can be formed.

Subsequently, as shown in process 110 (S110), electrodes are formed. The electrodes are formed by a sputtering process using gold, and the electrodes are formed on both surfaces of the displacement unit. In this way, the actuator in accordance with the present embodiment can be manufactured. Then, the electrodes are connected to a power supply and a voltage is applied thereto, so that the actuator can be operated. It is desirable to select a material of the electrode that is not separated from the displacement unit of the actuator and that can be deformed reversibly and flexibly by a small force. For this reason, desirably, carbon nanotubes, conductive polymers, and silver grease may be used as the material of the electrode in addition to gold.

The actuator manufactured according to the present embodiment may have a length of about 20 mm, a width of about 5 mm, and a thickness of about 50 μm.

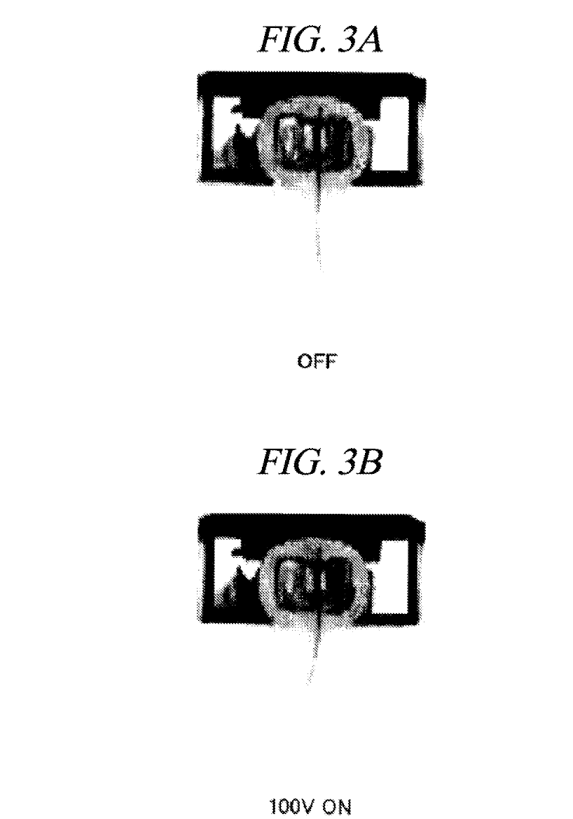

FIGS. 3A and 3B show operation states of the actuator. FIG. 3A shows the actuator in a state where a voltage is not applied between the electrodes, and FIG. 3B shows the actuator in a state where a voltage of about 100 V is applied between the electrodes. By applying the voltage between the electrodes, the whole actuator is deformed, and a front end of the actuator is displaced (curved). Accordingly, the actuator in accordance with the present embodiment can serve as an actuator due to such displacement. Further, in the present embodiment, the front end of the actuator can be displaced by about 3 mm by applying the voltage of about 100 V.

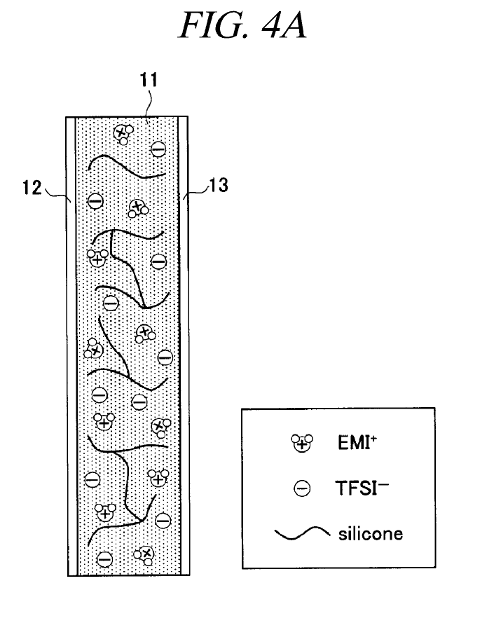

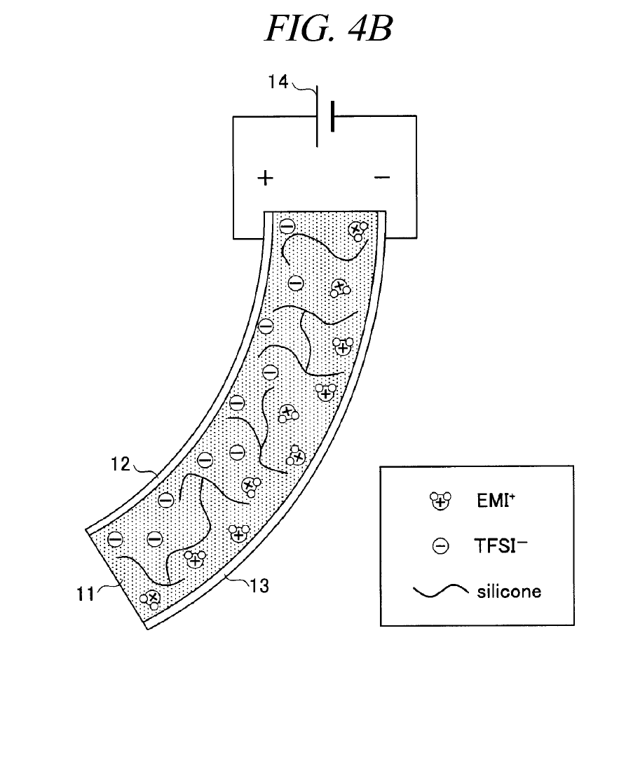

An operation of the actuator in accordance with the present embodiment will be explained with reference to FIGS. 4A and 4B. FIG. 4A shows the actuator in a state where a voltage is not applied between the electrodes 12 and 13. Referring to FIG. 4A, in the displacement unit 11, the ionic liquid is dispersed uniformly in the silicone-containing elastomer. As depicted in FIG. 4B, if a voltage is applied between the electrodes 12 and 13 from the power supply 14, in the displacement unit 11, EMI⁺ in the ionic liquid are attracted to a cathode, whereas TFSI⁻ in the ionic liquid are attracted to an anode. In this way, the displacement unit 11 is deformed by the polarization of the ionic liquid, so that the displacement is generated.

In the present embodiment, although it has been explained that the displacement unit 11 has a flat plate shape, the displacement unit may have a rod shape, a tube shape, or a fiber shape. Even if the displacement unit has any one of these shapes, the displacement unit may be deformed by applying an electric field thereto, and the actuator can serve as an actuator. In order to form the displacement unit in the rod shape, the tube shape or the fiber shape, the mold used in process S104 needs to have a shape corresponding to a desired shape such as the rod shape, the tube shape or the fiber shape, and, thus, the actuator can be manufactured by the above-described processes.

In the present embodiment, it has been explained that the electrodes are provided on both surfaces of the displacement unit 11. However, since the displacement unit 11 can be deformed even if the electric field is applied to a part of the displacement unit 11, electrodes may be provided such that an electric field is applied to a part of the displacement unit. Since the electrodes are provided to apply the electric field to the displacement unit, a multiple number of, i.e. two or more, electrodes need to be provided. Further, the electrodes may be provided asymmetrically on the displacement unit, and the electrodes may have different shapes or sizes from each other. In this way, the electric field can be non-uniformly applied to the displacement unit, and, thus, the displacement unit can be deformed into a desired shape. Accordingly, the actuator can serve as an actuator.

(Characteristic of Displacement Unit)

Hereinafter, there will be explained a compression test on the displacement unit of the actuator made of the mixture of the polydimethylsiloxane and the ionic liquid. To be specific, there will be explained a result of the compression test on the sample as the displacement unit formed through processes 102 to 108 as shown in FIG. 2 while changing a mixed amount of an ionic liquid.

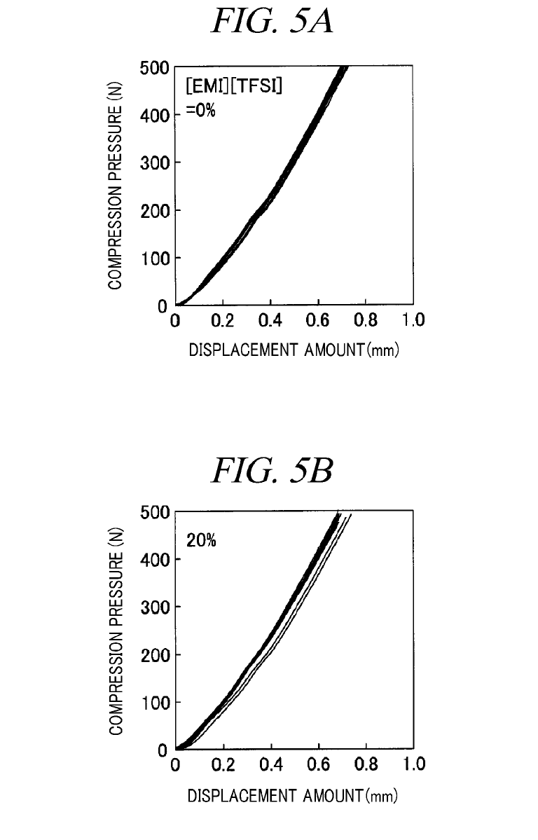

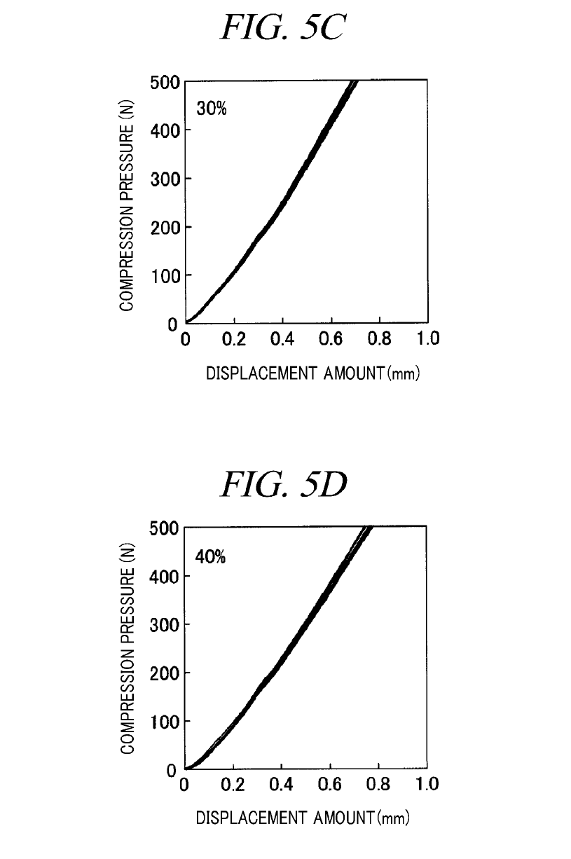

There will be explained a relationship between a compression pressure and a displacement amount when the compression pressure is applied to the sample as the displacement unit with reference to FIGS. 5A, 5B, 5C, 5D and 5E. Here, the sample may have a thickness of about 1 mm, and a circular-shaped compression area to which the compression pressure is applied may have a diameter of about 30 mm.

FIG. 5A shows that a silicone-containing elastomer is not mixed with [EMI][TFSI], FIG. 5B shows that a silicone-containing elastomer is mixed with about 20 wt % of [EMI][TFSI], FIG. 5C shows that a silicone-containing elastomer is mixed with about 30 wt % of [EMI][TFSI], FIG. 5D shows that a silicone-containing elastomer is mixed with about 40 wt % of [EMI][TFSI], and FIG. 5E shows that a silicone-containing elastomer is mixed with about 50 wt % of [EMI][TFSI].

As depicted in FIGS. 5A to 5D, when the mixed amount of the [EMI][TFSI] is about 0 wt % to about 40 wt %, as the compression pressure increases, the displacement amount also increases. In this case, the [EMI][TFSI] as the ionic liquid does not leak from the sample. Meanwhile, in FIG. 5E, as the compression pressure increases, there exists a portion where the displacement amount is discontinued. In this case, the ionic liquid leaks from the sample. Therefore, in order to maintain the displacement unit in a stable state, the mixed amount of the ionic liquid to be mixed with the silicone-containing elastomer may need to be, desirably, about 40 wt % or less.

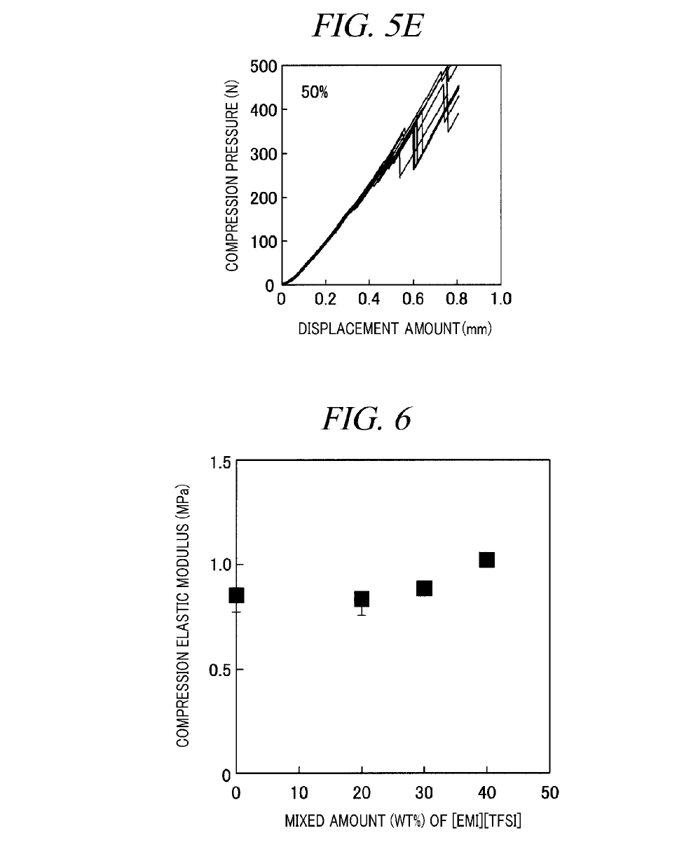

FIG. 6 shows a relationship between a mixed amount of [EMI][TFSI] and a compression elastic modulus in the sample made of the mixture of the [EMI][TFSI] and the silicone-containing elastomer. As can be seen from FIG. 6, even when the mixed amount of the [EMI][TFSI] is changed from about 0 wt % to about 40 wt %, the compression elastic modulus is substantially constant within a range of from about 0.8 MPa to about 1 MPa.

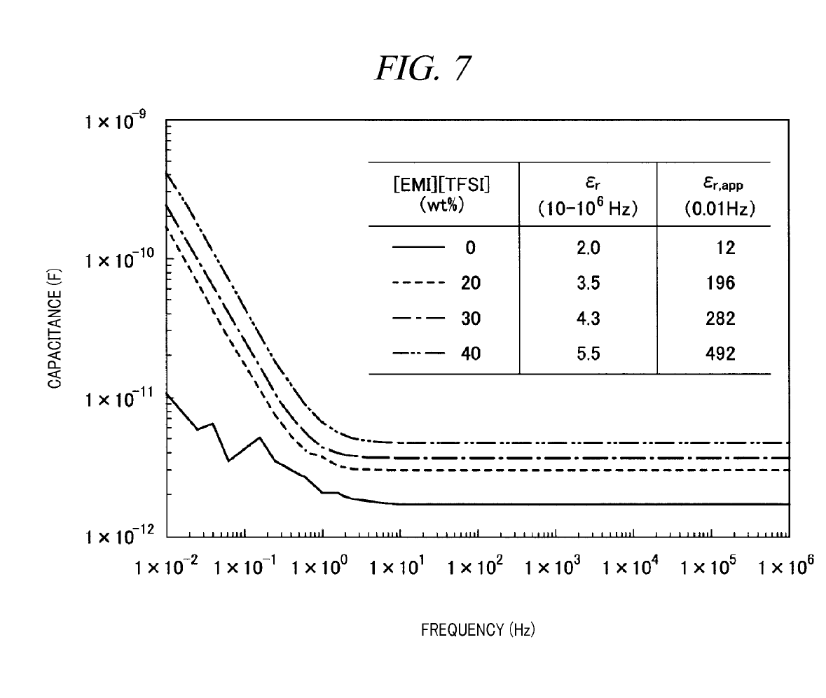

FIG. 7 shows capacitance of the sample made of the mixture of the [EMI][TFSI] and the silicone-containing elastomer. As the mixed amount of the [EMI][TFSI] increases, the capacitance also increases. Further, regardless of the mixed amount of the [EMI][TFSI], the capacitance thereof is substantially constant in a frequency range of from about 1 Hz to about 10⁶ Hz, but sharply increases in a frequency range of about 1 Hz or less. This increase may be caused by the ionic polarization due to an ion movement in the ionic liquid.

### EXPERIMENTAL EXAMPLE

### Experimental Example 1

As an experimental example 1, there will be explained a displacement amount when a pulse voltage is applied to the actuator of the first embodiment. Here, KE-106 (produced by Shin-Etsu Chemical Co., Ltd.) is used as a silicone-containing elastomer, and about 40 wt % of the [EMI][TFSI] as an ionic liquid is mixed with the silicone-containing elastomer. A displacement unit is formed through the above-described processes, and electrodes are formed by a sputtering process using gold. In this way, an actuator is manufactured. A film thickness of the displacement unit is about 100 μm.

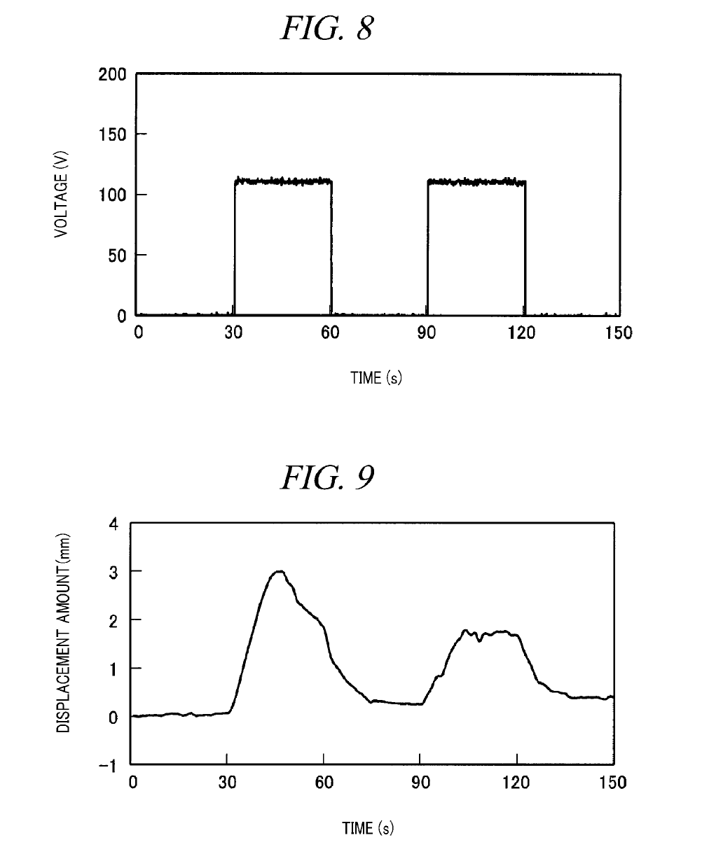

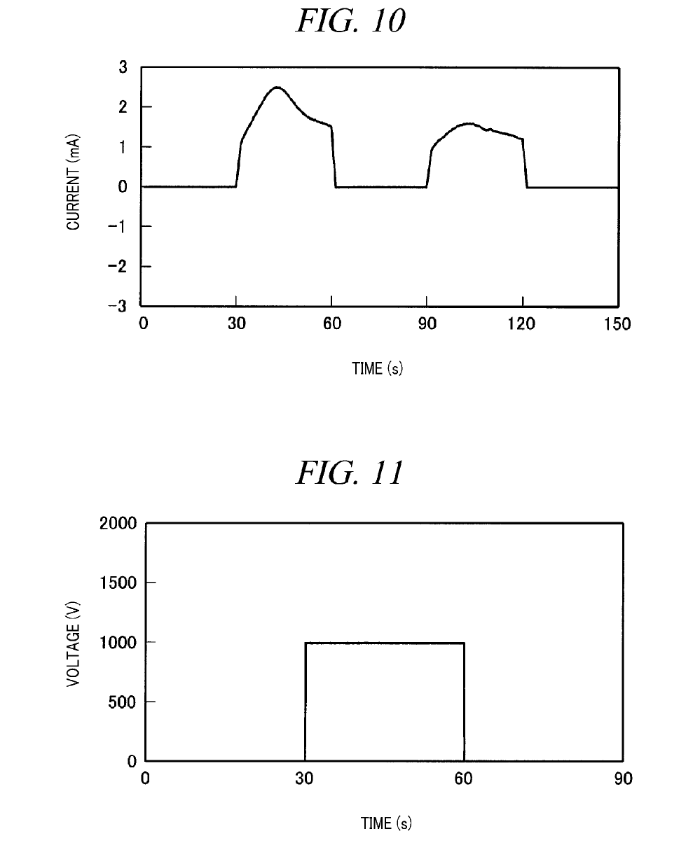

FIG. 8 shows a waveform of an AC voltage applied to the actuator in accordance with the experimental example 1. The AC voltage is a pulse voltage of about 110 V. FIG. 9 shows a displacement amount of a front end of the actuator of the present experimental example when the pulse voltage shown in FIG. 8 is applied. FIG. 10 shows a current at that time. As depicted in FIG. 9, the front end of the actuator of the present experimental example is displaced by about 3 mm. Further, at that time, the current is about 2 mA.

### Comparative Example 1

Hereinafter, as a comparative example 1, an actuator including a displacement unit made of a silicone-containing elastomer without being mixed with an ionic liquid is manufactured. KE-106 (produced by Shin-Etsu Chemical Co., Ltd.) is used as the silicone-containing elastomer in order to form the displacement unit, and electrodes are formed by a sputtering process using gold. In this way, an actuator is manufactured. Here, a film thickness of the displacement unit is about 100 μm.

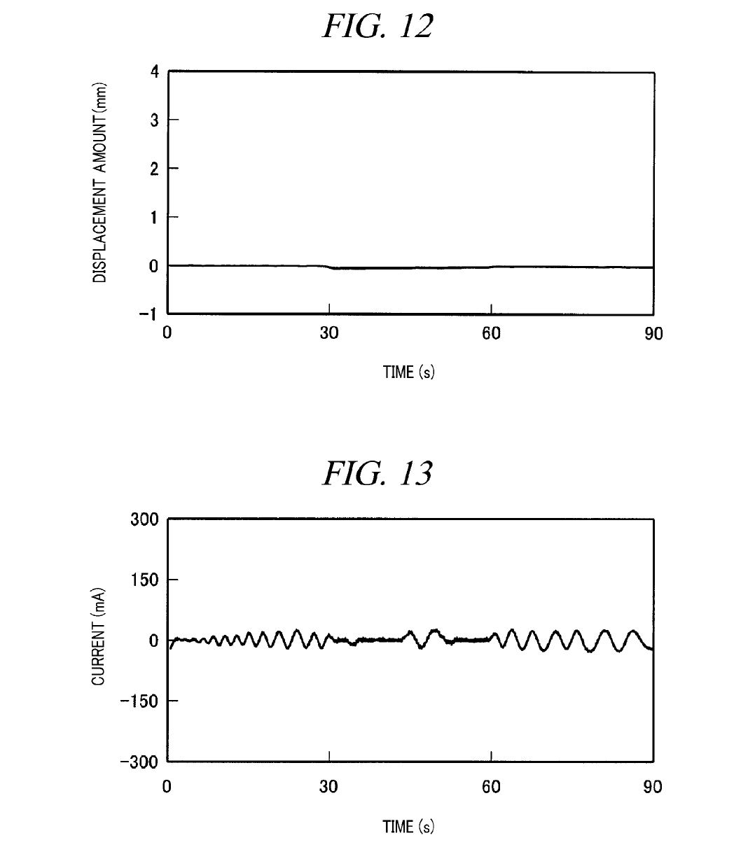

FIG. 11 shows a waveform of an AC voltage applied to the actuator in accordance with the comparative example 1. The AC voltage applied is a pulse voltage of about 1000 V. FIG. 12 shows a displacement amount of a front end of the actuator of the present comparative example when the pulse voltage shown in FIG. 11 is applied. FIG. 13 shows a current at that time. As depicted in FIG. 12, the front end of the actuator of the present comparative example is hardly displaced.

As can be seen from the above descriptions, the actuator of the experimental example 1 can be greatly displaced with a lower voltage as compared to the actuator of the comparative example 1.

### Experimental Example 2

As an experimental example 2, there will be explained a displacement amount when pulse voltages having different voltages are applied to the actuator of the first embodiment. As in the experimental example 1, KE-106 (produced by Shin-Etsu Chemical Co., Ltd.) is used as a silicone-containing elastomer, and about 40 wt % of [EMI][TFSI] as an ionic liquid is mixed with the silicone-containing elastomer. A displacement unit is formed through the above-described processes, and electrodes are formed by a sputtering process using gold. In this way, an actuator is manufactured. Here, a film thickness of the displacement unit is about 50 μm.

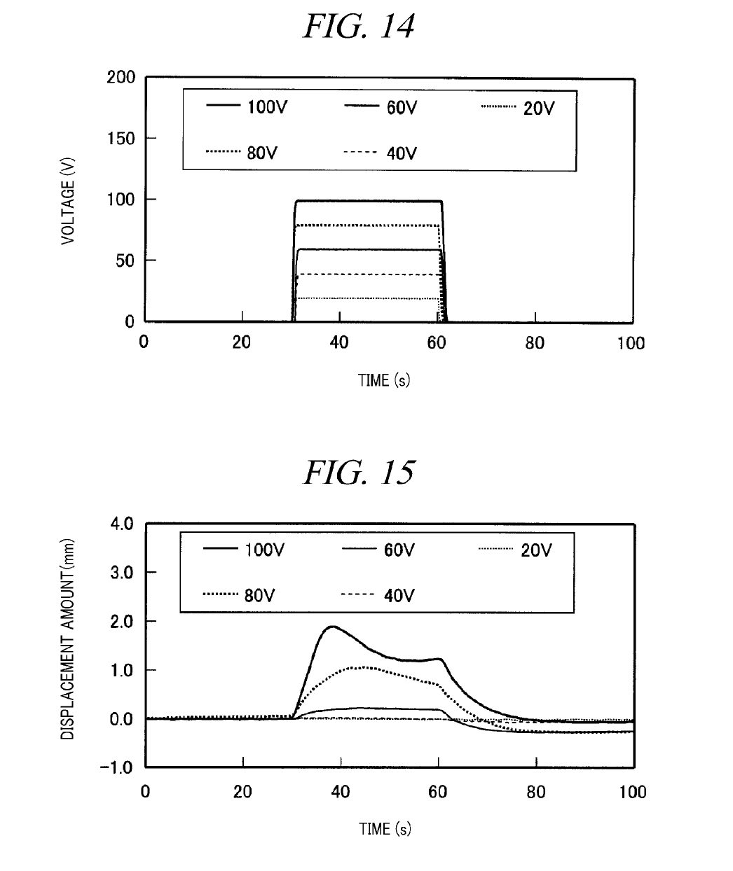

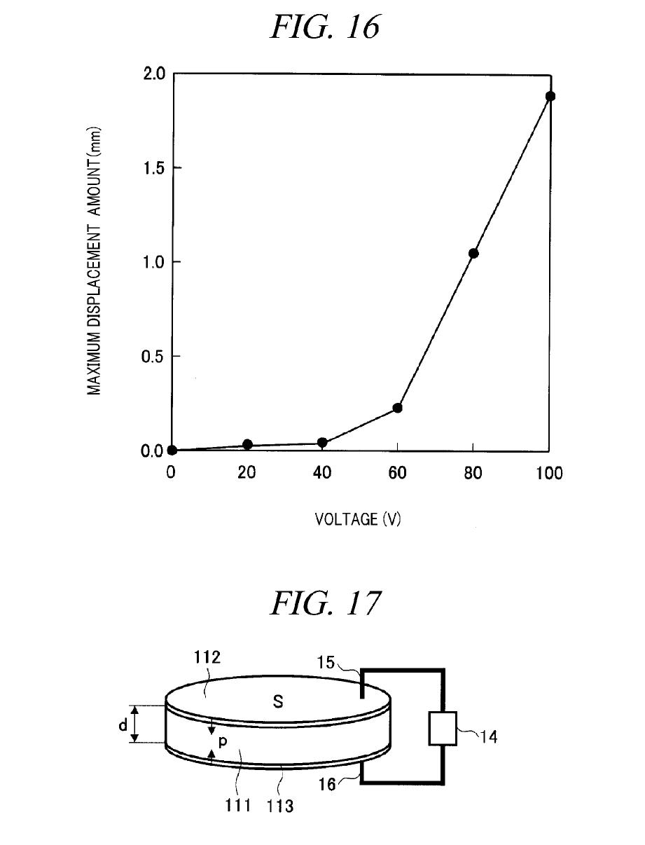

FIG. 14 shows waveforms of AC voltages applied to the actuator in accordance with the experimental example 2. FIG. 15 shows a displacement amount of a front end of the actuator of the present experimental example when the pulse voltages shown in FIG. 14 are respectively applied. As depicted in FIG. 15, as the voltage increases, the displacement amount increases. FIG. 16 shows a relationship between the voltage and the maximum displacement amount. As depicted in FIG. 16, the displacement amount sharply increases from about 60 V or more.

Some aspects of the present disclosure have been explained above, but the present disclosure is not limited to the above descriptions.

### Second Embodiment

Hereinafter, there will be explained a second embodiment. As depicted in FIG. 17, an actuator in accordance with the present embodiment includes a displacement unit 111 including an ionic liquid and a silicone-containing elastomer; and electrodes 112 and 113 provided on both sides of the displacement unit 111. The actuator is displaced in a thickness direction of the displacement unit 111. Further, the electrodes 112 and 113 are connected to a power supply 14 via electric wires 15 and 16, respectively. Accordingly, a voltage can be applied to the electrodes from the power supply 14.

Referring to FIG. 17, an electrostatic attractive force p(N) is expressed by an equation 1. Here, εᵣ denotes a specific permittivity (relative permittivity), ε₀ denotes a vacuum permittivity (8.85×10⁻¹² F/m), S denotes an area of a surface where the electrode is provided, V denotes an applied voltage (V), and d denotes a thickness (m) between the surfaces where the electrodes are provided.

$$p = {ɛ}_{r} \times {ɛ}_{0} \times S \times {( \frac{V}{d} )}^{2} \qquad [ Equation 1 ]$$

In the present embodiment, silicone KE-106 (produced by Shin-Etsu Chemical Co., Ltd.) is used as the silicone-containing elastomer. Further, as the ionic liquid, 1-ethyl-3-methylimidazolium bis(trifluoromethanesulfonyl)imide ([EMI][TFSI]) (produced by Kanto Chemical Co., Inc.) expressed by the chemical formula 8 is used.

A main component of the silicone KE-106 is mixed with a hardener, and the silicone KE-106 is hardened by heating the mixed solution. To be specific, the main component and the hardener are weighed at a ratio of about 10 to 1, and the main component and the hardener are mixed to each other by a magnetic stirrer for about 10 minutes. Then, the mixed solution is supplied into a mold, and air contained in the mixed solution is removed in a vacuum by using a vacuum oven (ADP 200, produced by Yamato Chemical Co. Ltd.). Thereafter, the mold is covered by a lid and is heated at about 150° C. for about 30 minutes. In this way, the silicone-containing elastomer can be produced. Further, a main component of the silicone KE-106 and a hardener are weighed at a ratio of about 10 to 1, and about 40 wt % of [EMI][TFSI] expressed by the chemical formula 8 is added thereto. The mixed solution is stirred for about 10 minutes. Then, silicone gel for forming the displacement unit 111 is produced in the same manner as the processes for producing the silicone-containing elastomer.

This silicone gel has a thickness of about 1 mm, and the silicone gel is cut to have a circle shape having a diameter of about 30 mm by using a laser marker (ML-Z9500, produced by Keyence Corporation). In this way, the displacement unit 111 can be produced. The displacement unit 111 is placed on a compression terminal of a mechanical tester (EZS, produced by Shimadzu Corporation), and load of about 100 N is applied thereto. Thereafter, the displacement unit 111 is left as it is until the stress relaxation is completed. Thereafter, a voltage is applied thereto by using a function generator (HB-104, produced by Hokuto Denko Ltd.) and an AC high speed/high voltage amplifier (HEOP-5B6, produced by Matsusada Precision Inc.). At this time, a change in the stress is measured by using TRAPEZIUM X. As a data input device, NR-HA08 and NR-500 (produced by Keyence Corporation) are used. The voltage is applied for about 10 seconds.

In order to examine an electric field responsiveness of the actuator in accordance with the present embodiment, for comparison, a member made of a silicone-containing elastomer (i.e., without being mixed with an ionic liquid) is manufactured in the same shape as the displacement unit 111 of the actuator in accordance with the present embodiment, and the electric field responsiveness of the member is compared with that of the displacement unit 111.

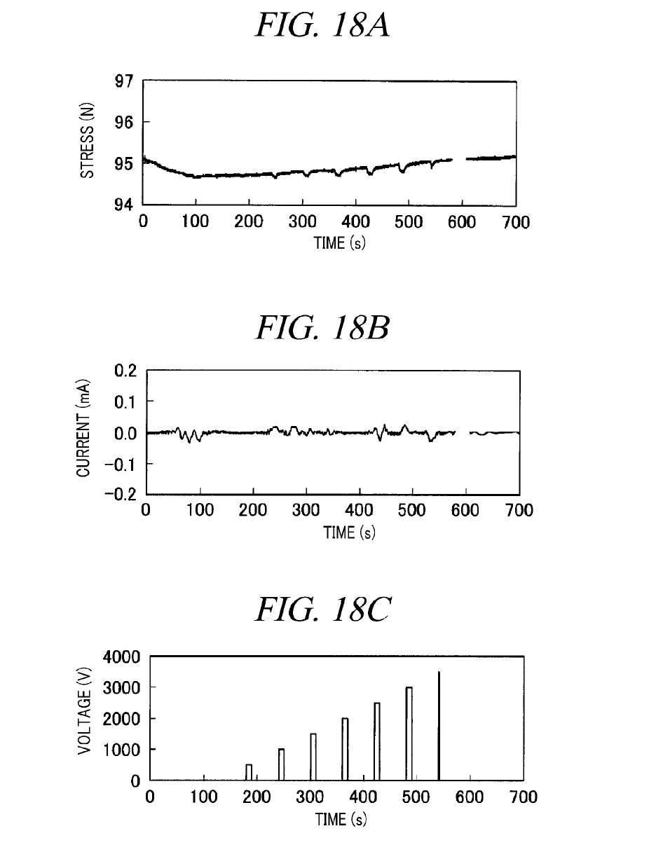

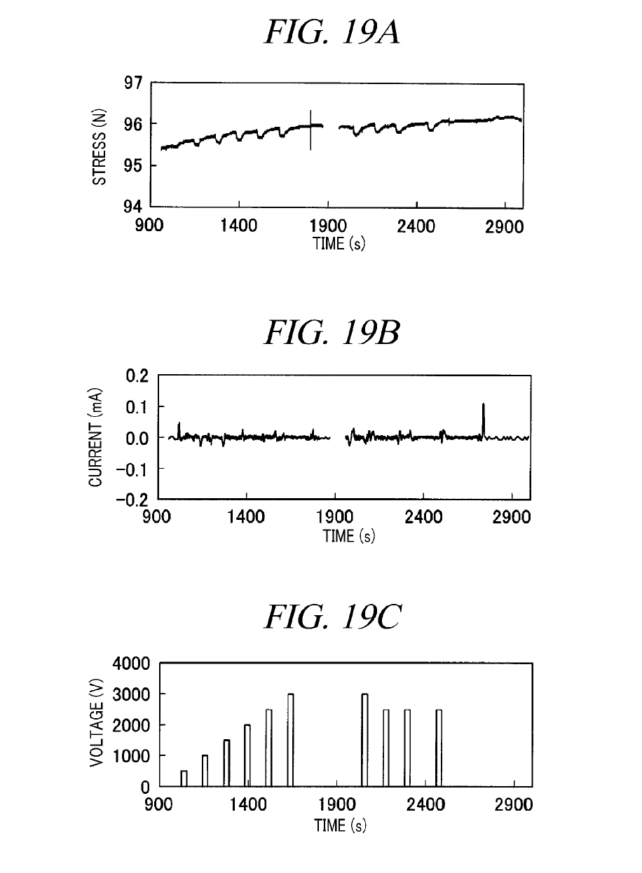

To be specific, the member manufactured for comparison, made of the silicone-containing elastomer, is compressed with about 100 N, and the stress relaxation proceeds for about several hours. A relationship between a stress change and a current when a DC voltage is applied to the member in a thickness direction thereof is shown in FIGS. 18A, 18B, 18C, 19A, 19B, and 19C. To be specific, FIGS. 18A, 18B, and 18C show measurement results within a time period between about 0 second to about 700 seconds, and FIGS. 19A, 19B, and 19C show measurement results within a time period between about 900 seconds to about 3000 seconds. Further, FIGS. 18A and 19A show the stress changes, FIGS. 18B and 19B show flowing currents, and FIGS. 18C and 19C show applied voltages.

As depicted in FIGS. 18A, 18B, 18C, 19A, 19B, and 19C, in the member made of the silicone-containing elastomer, the stress is decreased by about 0.15 N at the applied voltage of about 2000 V, and the stress is decreased by about 0.23 N at the applied voltage of about 3000 V. If the application of the voltage is stopped, the stress is increased and returns to its original state. Further, the current does not flow hardly when the voltage is applied. Furthermore, since FIGS. 18A, 18B, 18C, 19A, 19B, and 19C show substantially the same tendency, it may be deemed that the member is reversible and reproducible.

Meanwhile, an electrostatic attractive force p is roughly estimated under the condition of a specific permittivity (εᵣ=about 2.3) of the silicone-containing elastomer, an area (S=about 7.07×10⁻⁴ m²), an applied voltage (V=about 2000 V), and a film thickness (d=about 1 mm). As a result, the electrostatic attractive force p is calculated as about 0.06 N from an equation 2. This calculated value approximately closes to the above-described actual measurement value of about 0.15 N. In case of the silicone-containing elastomer, it may be assumed that the stress change is caused by the electrostatic attractive force.

$$\begin{matrix}p = {ɛ}_{r} \times {ɛ}_{0} \times S \times {( \frac{V}{d} )}^{2} \\ = \frac{\begin{matrix}2.3 \times 8.85 \times {10}^{- 12} ( F / m ) \times 7.07 \times \\ {10}^{- 4} ( {m}^{2} ) \times 4 \times {10}^{6} ( {V}^{2} )\end{matrix}}{{10}^{- 6} ( {m}^{2} )} \\ = 0.06 ( N )\end{matrix} \qquad [ Equation 2 ]$$

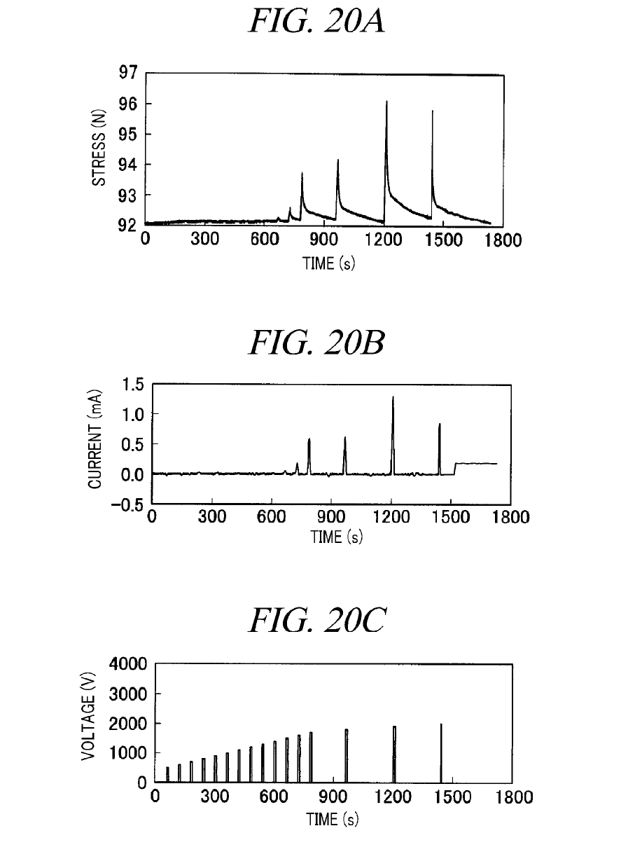

Hereinafter, there will be explained the case of the actuator in accordance with the present embodiment. To be specific, the displacement unit 111 is compressed with about 100 N, and the stress relaxation proceeds for about several hours. A relationship between a stress change and a current when a DC voltage is applied to the actuator in a thickness direction thereof is shown in FIGS. 20A, 20B, and 20C. Further, FIG. 20A shows a stress change, FIG. 20B shows a flowing current, and FIG. 20C shows an applied voltage.

As depicted in FIGS. 20A, 20B, and 20C, if a voltage is applied to the displacement unit 111, a high current of about 1 mA flows, and a compression stress is increased. If a voltage of about 1900 V is applied to the displacement unit 111, the compression stress is changed by about 4 N. That is, the change in the compression stress of the actuator is about 26 times greater than 0.15 N shown in the member made of the silicone-containing elastomer.

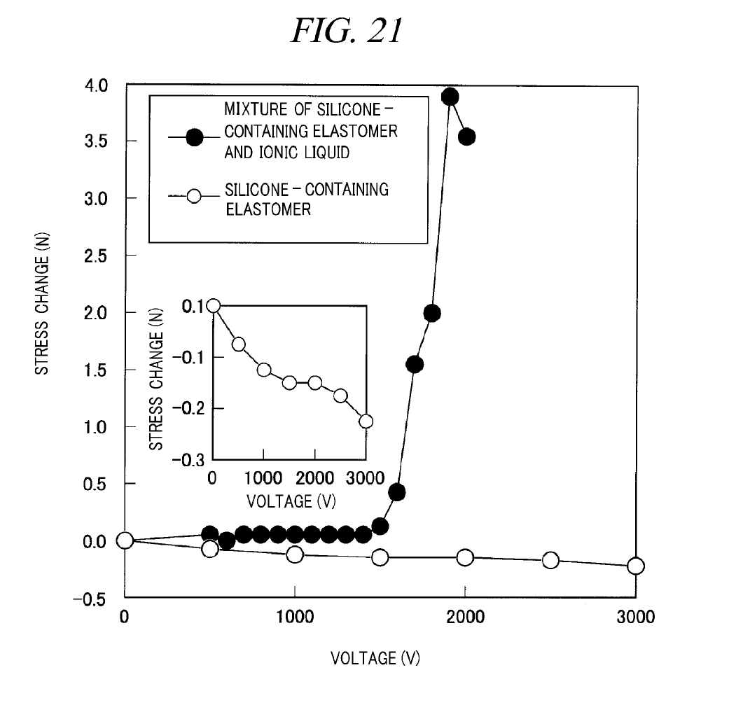

FIG. 21 shows a relationship between an applied voltage and a stress change in a silicone-containing elastomer and the mixture of the silicone-containing elastomer and the ionic liquid. When a voltage is applied to the displacement unit 111 of the actuator in accordance with the present embodiment, if the applied voltage is equal to or greater than a certain value, the stress change is sharply changed.

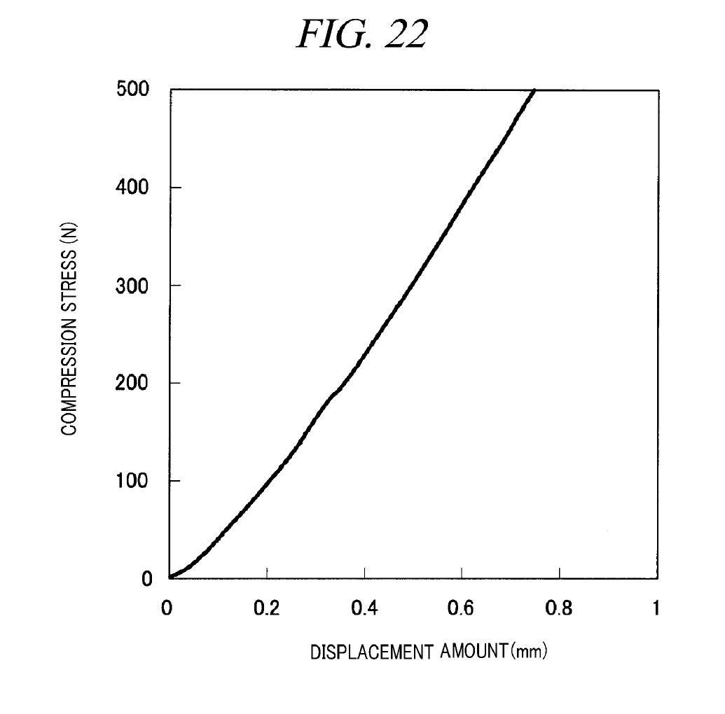

FIG. 22 is a stress strain characteristic view of the mixture of the silicone-containing elastomer and the ionic liquid. As depicted in FIG. 22, a compression elastic modulus of a material of the displacement unit 111 is about 1 MPa. An expansion coefficient γ required to increase a compression stress applied to the displacement unit 111 by about 4 N is calculated as about 0.57% from an equation 3. Here, the displacement unit 111 may have a thickness d of about 1 mm and an area S of about 7.07×10⁻⁴ m². Further, since the expansion coefficient γ is about 0.57%, the actuator in accordance with the present embodiment, including the displacement unit 111 having the thickness d of about 1 mm, is displaced by about 5.7 μm in a thickness direction thereof.

$$γ = \frac{4 ( N )}{{10}^{6} ( N \text{/} {m}^{2} ) \times 7.07 \times {10}^{- 4} ( {m}^{2} )} \times 100 ( \% ) = 0.57 \% \qquad [ Equation 3 ]$$

Meanwhile, since a current of about 1.3 mA flows when a voltage of about 1900 V is applied for about 10 seconds, electric energy Q applied to the displacement unit 111 is calculated as about 24.7 J from an equation 4.

Q=V×I×t=1900 (V)×1.3×10⁻³ (A)×10 (s)=24.7 J [Equation 4]

Assuming that all of the energy is converted into heat, if the mass of the displacement unit 111 is about 0.942 g and the specific heat C is about 1.6 J/gK, a temperature change is roughly estimated as 16.4° C. from an equation 5.

$$Δ T = \frac{Q}{m \times C} = \frac{24.7 ( J )}{0.942 ( g ) \times 1.6 ( J \text{/} gK )} = 16.4 ° C . \qquad [ Equation 5 ]$$

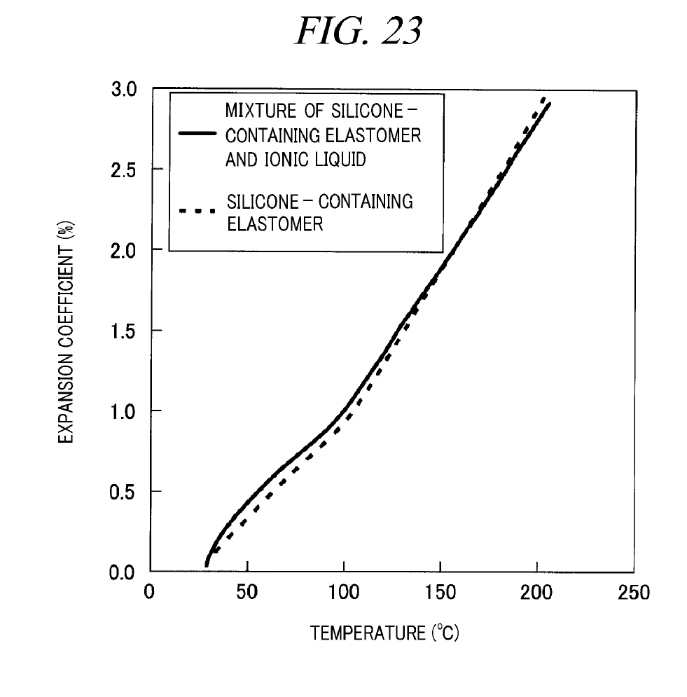

FIG. 23 is a thermal stress strain characteristic view showing a thermal stress strain curve (TMA) in the silicone-containing elastomer and the mixture of the silicone-containing elastomer and the ionic liquid. To be specific, the thermal stress strain characteristic is measured by a thermal stress strain measurement device (6000 TMA/SS, produced by SII NanoTechnology Inc.). As measurement conditions, a thickness of a sample is about 2 mm, a distance between chucks is about 20 mm, an applied load is about 49 mN, a sampling time is about 1 second, and a temperature rising rate is about 1° C./min. Referring to FIG. 23, if the measurement is carried out at a temperature of about 25° C., when the temperature is increased from 25° C. by about 16.4° C., a thermal expansion coefficient becomes about 0.32%. Here, the thermal expansion coefficient of about 0.32% is equivalent to about a half of the expansion coefficient (about 0.57%) required to increase the compression stress by about 4 N. It may be deemed that a stress change shown in the displacement unit 111 is caused by other factors than the heat. By way of example, it may be assumed that a stress change is caused by anisotropic deformation due to ionic polarization.

As described above, the actuator in accordance with the present embodiment includes the above-described displacement unit 111. Accordingly, the actuator can be displaced in a thickness direction thereof, and the actuator can fully serve as an actuator. Further, in the above-described experiment, the experiment is carried out in a state where the pressure is applied to the actuator by a mechanical tester. However, it may be deemed that even if the pressure is not applied, a stress change can be seen. That is, the actuator in accordance with the present embodiment can be displaced in a thickness direction thereof even if the pressure is not applied.

Furthermore, as the ionic liquid to be used for producing the displacement unit 111 of the actuator in accordance with the present embodiment, the ionic liquid described in the first embodiment can be used. Other details are substantially the same as the first embodiment.

The present application claims a priority to Japanese Patent Application No. 2009-175333 filed on Jul. 28, 2009, the entire contents of which are incorporated herein by reference.

Further, the present application claims a priority to International Application No. PCT/JP2009/065051 filed on Aug. 28, 2009, the entire contents of which are incorporated herein by reference.

### EXPLANATION OF CODES

1: Displacement unit
12: Electrode
13: Electrode
14: Power supply
15: Electric wire
16: Electric wire
111: Displacement unit
112: Electrode
113: Electrode

1. An actuator comprising:
a displacement unit made of a mixture of a silicone-containing elastomer and an ionic liquid; and
a plurality of electrodes provided to apply an electric field to a part or whole of the displacement unit,
wherein the displacement unit is deformed by applying a voltage between the plurality of electrodes.

2. The actuator of claim 1,
wherein the displacement unit has a flat plate shape, and
the plurality of electrodes are provided on both surfaces of the displacement unit.

3. The actuator of claim 1,
wherein the ionic liquid is one selected from 1-ethyl-3-methylimidazolium tetrafluoroborate, 1-butyl-3-methylimidazolium tetrafluoroborate, 1-hexyl-3-methylimidazolium tetrafluoroborate, 1-ethyl-3-methylimidazolium2-(2-methoxyethoxy)ethyl sulfate, 1-ethyl-3-methylimidazolium bis(trifluoromethanesulfonyl)imide, and 1-butyl-1-methylpyrrolidinium bis(trifluoromethanesulfonyl)imide.

4. The actuator of claim 1,
wherein the ionic liquid contained in the mixture is about 40 wt % or less.

5. The actuator of claim 1,
wherein the plurality of electrodes is made of one selected from gold, a carbon nanotube, a conductive polymer, and silver grease.

6. The actuator of claim 1,
wherein the displacement unit is deformed by being curved.

7. The actuator of claim 1,
wherein the displacement unit is deformed in a thickness direction thereof.

8. An actuator manufacturing method comprising:
producing a mixed solution by mixing a silicone-containing elastomer and an ionic liquid;
supplying the mixed solution into a mold;
after supplying the mixed solution into a mold, removing air contained in the mixed solution;
after removing air contained in the mixed solution, performing a heat treatment on the mixed solution; and
after performing a heat treatment, taking a solid mixture solidified from the mixed solution out of the mold and providing a plurality of electrodes on the solid mixture.
